(19) United States
(12) Patent Application Publication
(10) Pub. No.: US 2005/0020744 A1
(43) Pub. Date: Jan. 27, 2005

(54) Coating composition and process for its preparation

(76) Inventors: Ivan Cabrera, Dreieich (DE); Volker Renisch, Hofheim (DE)

Correspondence Address: CONNOLLY BOVE LODGE & HUTZ, LLP, P O BOX 2207, WILMINGTON, DE, 19899, US

(21) Appl. No.: 10/895,575

(22) Filed: Jul. 21, 2004

(30) Foreign Application Priority Data
Jul. 24, 2003 (DE) DE 103 33 623.0

(51) Int. Cl. C08K 3/00; C08K 5/05

(52) U.S. Cl. 524/386; 524/589

(57) ABSTRACT

A description is given of an aqueous coating composition comprising a) a polymer dispersion based on (meth)acrylate homopolymers and/or (meth)acrylate copolymers and prepared by emulsion polymerization in the presence of a protective colloid, b) if desired, pigments and/or fillers, with a pigment volume concentration (PVC) of O to 30%, c) if desired, leveling assistants, d) if desired, coalescers, e) if desired, polymeric thickeners, and f) if desired, further, customary additives. The composition is distinguished by an increased open time.

The invention relates to new coating compositions with improved open time and to processes for preparing them.

The use of aqueous polymer dispersions for preparing coating compositions is conventional.

One particularly important property associated with the processing of coating materials is the open time. In the case of physically drying paints the open time is taken to be that period of time within which a second coat can be applied to paint which is still wet, without a visible “seam” after drying.

In accordance with the state of the art the open time that is desired in a particular case is generally set by addition of glycols or high-boiling solvents. In many cases a desired open time can be achieved simply by adding suitable film-forming assistants. With emissions-free and solvent-free paints it is not generally possible to add solvents. In that case, therefore, the setting of the open time can be problematic.

An open time in the region of ten minutes is regarded as optimum for coating materials, since within this period of time it is still possible to carry out corrections. The disadvantage of a longer open time is a susceptibility to soiling.

The prior art, in addition to the measures referred to above, discloses additional methods of influencing the open time of coating materials.

U.S. Pat. No. 6,303,189 describes a process for increasing the open time of aqueous coating compositions, using aqueous polyurethane dispersions and coalescers. In comparative examples it is shown that aqueous coating compositions based on acrylate dispersions which do not contain a polyurethane dispersion have a markedly reduced open time.

EP-A-593,151 describes a process for increasing the open time, using a latex and a modifier which contain groups which are reactive with one another.

WO-A-02/32,980 discloses aqueous polyurethane coating materials which comprise aqueous polyurethane oligomer dispersions and have an open time of at least 20 minutes.

EP-A-62,106 describes a process for preparing copolymers having increased water resistance, by emulsion polymerization in the presence of polyvinyl alcohol as protective colloid.

EP-A-538,571 discloses the preparation of aqueous and emulsifier-free dispersions, selected monomers being reacted in the presence of selected polyvinyl alcohols in a monomer feed process.

In the prior art processes for increasing the open time a modifier, generally a selected polymer, is added to the coating composition.

The object on which the present invention is based is to provide a new coating composition for which the open time can be varied by means of simple measures and without the addition of special auxiliaries.

Another object of the present invention relates to the provision of a new process for precisely adjusting the open time of coating compositions.

The present invention provides an aqueous coating composition comprising
a) a polymer dispersion based on (meth)acrylate homopolymers and/or (meth)acrylate copolymers and prepared by emulsion polymerization in the presence of a protective colloid,
b) if desired, pigments and/or fillers, with a pigment volume concentration (PVC) of 0 to 30%,
c) if desired, leveling assistants,
d) if desired, coalescers,
e) if desired, polymeric thickeners, and
f) if desired, further, customary additives.

The polymer dispersion used in accordance with the invention is prepared by emulsion polymerization in which the monomer is metered continuously or discontinuously.

Distinctive for the polymer dispersion used in accordance with the invention is its preparation in the presence of a selected stabilizer or stabilizer mixture that acts as protective colloid.

As stabilizers it is possible to use the conventional polymeric substances which act as protective colloids. Examples thereof are cellulose ethers, polyethylene oxides, starch derivatives or, in particular, polyvinyl alcohol.

In addition to the protective colloids it is possible in the emulsion polymerization to use further stabilizers, such as low molecular mass emulsifiers, based for example on sulfates, sulfonic acids, carboxylic acids or polyethylene oxide.

Preference is given to polymer dispersions prepared in the absence of emulsifiers.

Distinctive for the invention is that the protective colloids are present during the actual emulsion polymerization. If desired it is also possible to add protective colloids and/or emulsifiers after the end of polymerization as well.

Particular preference is given to using polyvinyl alcohol as protective colloid.

Typical polyvinyl alcohols used in accordance with the invention have a number-average molecular weight in the range from 14 000 to 205 000 (measured at 20° C. by the method of gel permeation chromatography (GPC)) (corresponding to the viscosity of a 4% strength aqueous solution at 20° C. of from 2 to 70 mpa*s; measured with the falling-ball viscometer in accordance with Höppler, DIN 53015).

Polyvinyl alcohol is generally prepared by hydrolyzing polyvinyl acetate.

Particularly suitable polyvinyl alcohol possesses preferably a degree of hydrolysis of from 70 to 100 mol %, and its aqueous solution possesses a viscosity at 20° C. of from 2 to 70 mpa*s.

Other suitable polyvinyl alcohols may have been modified hydrophilically or hydrophobically in any way.

Examples of hydrophobically modified polyvinyl alcohols containing water-soluble monomer units in their main chain are ethylene-containing polyvinyl alcohols of the Exceval® type from Kuraray.

Another possibility is that of modification by grafting reactions on the alcohol groups, such as the partial acetalization of the alcohol groups of the polyvinyl alcohol, for example, where the polyvinyl alcohols may be provided with any desired radicals, which may be either hydrophobic or hydrophilic, such as, for example, polyvinyl alcohols of the Mowiflex® type from Kuraray.

The polyvinyl alcohols used in accordance with the invention are preferably dissolved at the beginning of polymerization (usually in water and in two to three hours at at least 90° C.) and introduced prior to the polymerization.

The total amount of protective colloids used before and during the emulsion polymerization is typically from 1 to 20% by weight, preferably from 2 to 12% by weight, and more preferably from 3 to 11% by weight, based on the total amount of the monomers used.

It is possible for all of the stabilizer and, where appropriate, emulsifier to be introduced right at the beginning of the emulsion polymerization; alternatively and preferably, some of the stabilizer and, where appropriate, the emulsifier is introduced at the beginning and the remainder is added, continuously or in one or more steps, after the polymerization has been initiated. The addition may take place separately or together with other components, such as monomers and/or initiators.

The polymer dispersion used in according to the invention and based on (meth)acrylates is derived from acrylates and/or methacrylates, which, together where appropriate with further monomers copolymerizable therewith, especially ethylenically unsaturated hydrocarbons and/or small amounts of ethylenically unsaturated, ionic comonomers, are obtainable by free-radical emulsion polymerization.

The acrylates are typically esters of acrylic acid with alcohols, preferably with alkanols having one to twelve, preferably one to eight, and in particular one to four carbon atoms, such as methanol, ethanol, n-butanol, isobutanol or 2-ethyl-hexanol, in particular.

Preferred monomers of this type are methyl, ethyl, n-butyl, isobutyl, and 2-ethylhexyl acrylate.

The methacrylates are typically esters of methacrylic acid with alcohols, preferably with alkanols containing one to twelve, preferably one to eight, and in particular one to four carbon atoms, such as methanol, ethanol, n-butanol, isobutanol or 2-ethylhexanol, in particular.

Preferred monomers of this type are methyl, ethyl, n-butyl, isobutyl, and 2-ethylhexyl methacrylate.

Besides these acrylic and methacrylic esters it is possible for the polymer dispersions used in accordance with the invention to derive as well from further α,β-monoethylenically unsaturated monocarboxylic and dicarboxylic esters, such as, for example, from maleic esters and itaconic esters with the abovementioned alcohols.

In addition it is possible for the polymer dispersions used in accordance with the invention to include small amounts of units derived from ethylenically unsaturated ionic comonomers: for example, from α,β-monoethylenically unsaturated monocarboxylic and dicarboxylic acids, such as from acrylic acid, methacrylic acid, maleic acid, and itaconic acid, and their water-soluble salts.

The fraction of these units derived from ethylenically unsaturated ionic comonomers is generally less than 2% by weight, based on the overall fraction of the monomers.

Besides the (meth)acrylic esters, the polymer dispersions used in accordance with the invention preferably contain further units derived from ethylenically unsaturated hydrocarbons.

These are generally aromatic or aliphatic α,β-unsaturated, optionally halogen-substituted hydrocarbons, such as ethene, propene, 1-butene, 2-butene, vinyl chloride, vinylidene chloride, styrene, α-methylstyrene, and o-chlorostyrene, preference being given to ethene and styrene.

It is further possible to use esters of vinyl alcohol with monocarboxylic acids containing one to eighteen carbon atoms, such as vinyl acetate, vinyl propionate, vinyl n-butyrate, vinyl laurate, vinyl stearate, and Versatic acid vinyl esters.

It is also possible, moreover, to use nitrites of α,β-monoethylenically unsaturated carboxylic acids, such as acrylonitrile; and/or to use conjugated dienes having four to eight carbon atoms, such as 1,3-butadiene and isoprene.

The (meth)acrylic esters and the ethylenically unsaturated hydrocarbons generally form the principal monomers, which, based on the total amount of monomers to be polymerized by the method of free-radical aqueous emulsion polymerization, normally account for a fraction of more than 50% by weight.

As a general rule these monomers display only moderate to low solubility in water under standard conditions (25° C., 1 atm).

It is of course possible to add further comonomers which modify the properties in a specific way. Such monomers are normally copolymerized only as modifying monomers, in amounts, based on the total amount of the monomers to be polymerized, of less than 50% by weight, generally from 0.5 to 20%, preferably from 1 to 10% by weight.

Monomers which normally increase the internal strength of films formed from the aqueous polymer dispersions normally contain at least one epoxy, hydroxyl, N-methylol or carbonyl group, or at least two nonconjugated ethylenically unsaturated double bonds.

Examples thereof are N-alkylol amides of α,β-monoethylenically unsaturated carboxylic acids containing three to ten carbon atoms, among which very particular preference is given to N-methylolacrylamide and N-methylol-methacrylamide, and also their esters with alkanols containing one to four carbon atoms. Also suitable additionally are monomers containing two vinyl radicals, monomers containing two vinylidene radicals, and monomers containing two alkenyl radicals.

Particularly advantageous in this context are the diesters of dihydric alcohols with α,β-monoethylenically unsaturated monocarboxylic. acids, among which acrylic acid and methacrylic acid are preferred.

Examples of monomers of this kind containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylates, and also divinylbenzene, vinyl methacrylate, vinyl acrylate, allyl methacrylate, allyl acrylate, diallyl maleate, diallyl fumarate, methylenebisacrylamide, cyclopentadienyl acrylate or triallyl cyanurate.

Also of particular importance in this context are the methacrylic and acrylic C₁-C₉ hydroxyalkyl esters, such as n-hydroxyethyl, n-hydroxypropyl or n-hydroxybutyl acrylate and methacrylate, and also compounds such as diacetoneacrylamide and acetylacetoxyethyl acrylate and methacrylate.

It is additionally possible to use organosilicon monomers of the general formula R³Si(CH₃)₀₋₂(OR⁴)₃₋₁ as well, Where R³ has the definition CH₂═CR⁴—(CH₂)₀₋₁ or CH₂═CR⁵CO₂—(CH₂)₁₋₃, R⁵ is an unbranched or branched, optionally substituted alkyl radical having three to twelve carbon atoms, which if desired can be interrupted by an ether group, and R⁴ is H or CH₃.

Examples thereof are vinylmethyldimethoxysilane, vinylmethyldiethoxysilane, vinylmethyldi-n-propoxysilane, vinylmethyldiisopropoxysilane, vinylmethyldi-n-butoxysilane, vinylmethyldi-sec-butoxysilane, vinylmethyldi-tert-butoxysilane, vinylmethyldi(2-methoxyisopropyloxy)silane, and vinylmethyldioctyloxysilane.

The aforementioned monomers are usually copolymerized in amounts of from 0.2 to 10% by weight, based on the total amount of the monomers to be polymerized.

The preparation of aqueous polymer dispersions has been described many times before and is therefore known to the skilled worker [cf., e.g., Encyclopedia of Polymer Science and Engineering, Vol. 8, p. 659 ff (1987)].

It takes place by emulsion polymerization of at least one (meth)acrylic ester and, if desired, further ethylenically unsaturated monomers in the presence of a preferably water-soluble polymerization initiator and in the presence of protective colloids, emulsifiers where appropriate, and conventional further additives.

In this case the addition of the monomers takes place generally by continuous feed.

The polymerization of the ethylenically unsaturated monomers takes place in the presence of at least one initiator for the free-radical polymerization of the ethylenically unsaturated monomers.

Suitable initiators for the free-radical polymerization, for initiating and continuing the polymerization during the preparation of the dispersions, include all known initiators capable of initiating free-radical aqueous emulsion polymerization.

These may be either peroxides, such as alkali metal peroxodisulfates, for example, or azo compounds.

As polymerization initiators it is also possible to use what are called redox initiators, which are composed of at least one organic and/or inorganic reducing agent and at least one peroxide and/or hydroperoxide, such as, for example, tert-butyl hydroperoxide with sulfur compounds, such as the sodium salt of hydroxymethanesulfinic acid, sodium sulfite, sodium disulfite, sodium thiosulfate, and acetone bisulfite adduct, or hydrogen peroxide with ascorbic acid; as further reducing agents which are able to form free radicals with peroxides it is also possible to use reducing sugars.

Use may also be made of combined systems, which contain a small amount of a metal compound which is soluble in the polymerization medium and whose metallic component is able to exist in a plurality of valence states, such as, for example, ascorbic acid/iron(II) sulfate/hydrogen peroxide, the ascorbic acid also frequently being replaced by the sodium salt of hydroxymethanesulfinic acid, acetone bisulfite adduct, sodium sulfite, or sodium hydrogen sulfite or sodium bisulfite, and the hydrogen peroxide by organic peroxides such as tert-butyl hydroperoxide or alkali metal peroxodisulfates and/or ammonium peroxodisulfate, for example. Instead of said acetone bisulfite adduct it is also possible to use other bisulfite adducts known to the skilled worker, such as those described, for example, in EP-A-778,290 and in the literature references cited therein.

Further preferred initiators are peroxodisulfates, such as sodium peroxodisulfate, for example.

The amount of the initiators or initiator combinations used for the emulsion polymerization is within the bounds of what is customary for aqueous emulsion polymerizations. In general the amount of initiator used will not exceed 5% by weight, based on the total amount of the monomers to be polymerized.

Preferably the amount of the initiators used, based on the total amount of the monomers to be polymerized, is from 0.05 to 2.0% by weight.

The total amount of initiator can be introduced at the beginning of the emulsion polymerization or, preferably, one portion of the initiator is introduced at the beginning and the remainder is added, continuously or in one or more steps, after the polymerization has been initiated. The addition may be made separately or together with other components, such as monomers and/or stabilizers.

The molecular weight of the emulsion polymers of the aqueous polymer dispersions can be adjusted by adding small amounts of one or more substances which regulate the molecular weight. These regulators, as they are called, are generally used in an amount of up to 2% by weight, based on the monomers to be polymerized. As regulators it is possible to use all of the substances known to the skilled worker. Preference is given, for example, to organic thio compounds, silanes, allyl alcohols, and aldehydes.

The aqueous polymer dispersion may further comprise a series of additional substances, such as plasticizers, preservatives, pH modifiers and/or defoamers, for example.

The polymerization temperature is generally from 20 to 150° C. and preferably from 60 to 120° C. Polymerization takes place under superatmospheric pressure if desired.

Following the polymerization reaction proper it may be desirable and/or necessary largely to free the resulting aqueous polymer dispersion from odoriferous substances, such as residual monomers and other volatile organic components, for example. This can be done in a manner known per se, physically for example, by distillative removal (in particular by way of steam distillation) or by stripping with an inert gas. Further, the level of residual monomers can also be lowered chemically, by means of free-radical postpolymerization, in particular under the action of redox initiator systems, as described in DE-A4,435,423, for example. Preference is given to postpolymerization with a redox initiator system comprising at least one organic peroxide and one organic and/or inorganic sulfite.

Particular preference is given to a combination of physical and chemical methods, in which case after the residual monomer content has been lowered by chemical postpolymerization it is lowered further by means of physical methods to preferably <1000 ppm, more preferably <500 ppm, in particular <100 ppm.

The monomer components can be introduced at the outset or, advantageously, can be metered in during polymerization, at a uniform rate or in accordance with metering profiles.

The emulsion polymerization is normally carried out at a pH in the region of less than/equal to 9. To adjust the pH of the polymer dispersion it is possible in principle to use buffer systems, such as sodium acetate, for example.

Preference is given to a pH range of from 2 to 9 advantageously; a pH value in the range between 3 and 8 is preferred.

The solids content of the polymer dispersions of component a) used in accordance with the invention is typically between 40 and 80% by weight, preferably between 50 and 75%, and more preferably between 50 and 70%.

The weight figures are based in this case on the overall mass of the dispersion. As component b) it is possible to use the pigments and/or fillers which are known per se for use in coating compositions. These are solids on an organic and/or inorganic basis, which are used preferably as powders. Pigments for the purposes of this description are solids which have a refractive index of greater than or equal to 1.75. Fillers for the purposes of this description are solids having a refractive index of less than 1.75.

Examples of pigments are metal oxides, particularly titanium dioxide.

Examples of fillers are alkaline earth metal oxides and/or sulfates, particularly calcium carbonate or barium sulfate.

The pigments and/or fillers, if present, are in the coating composition of the invention in pigment volume concentrations (PVC) of up to 30%. This corresponds to a maximum volume of 30 parts per 100 parts of the dry coating.

Particular preference is given to coating compositions comprising pigments and/or fillers which are exclusively finely divided and have average particle sizes D₅₀ of less than or equal to 0.4 μm, preferably from 0.1 to 0.4 μm, very preferably from 0.2 to 0.3 μm.

As component c) it is possible to use the leveling assistants which are known per se. These are water-miscible organic solvents, preferably water-miscible polyhydric alcohols, some of whose alcohol groups may have been etherified. Preference is given to using 1,2-propylene glycol, methyl diglycol, and butyl diglycol.

“Water-miscible” for the purposes of this description means that the leveling assistant is miscible with water in any proportion at 20° C.

As component d) it is possible to use the coalescers known per se. These are organic solvents which are immiscible or of low miscibility with water, preferably water-immiscible or low-water-miscibility polyhydric alcohols which are (partly) esterified and/or (partly) etherified. They can be diesters, ester alcohols, diethers, ether alcohols or alcohol ether esters derived from polyhydric alcohols. Examples thereof include 2,2,4-trimethyl-1,3-pentanediol monoisobutyrate, ethylene glycol 2-ethylhexyl ether, ethylene glycol butyl ether, ethylene glycol propyl ether, dipropylene glycol monopropyl ether, tripropylene glycol monopropyl ether, dipropylene glycol monobutyl ether, tripropylene glycol monobutyl ether, butyl diglycol acetate, diisobutyl adipate, diisobutyl glutarate, diisobutyl succinate or mixtures of two or more of these compounds. The term “of low miscibility with water” or “low-water-miscibility” refers for the purposes of this description to a water miscibility at 20° C. of less than 10% by weight, preferably of less than 6.5% by weight at 20° C.

As component e) it is possible to use the polymeric thickeners which are known per se. These are hydrophobically modified polyurethane or polyacrylate dispersions, such as the product Mowilith® LDM 7002 or Mowilith® VDM 7000.

Suitable further additives f) include dispersants, wetting agents, defoamers or buffers.

In one preferred embodiment the coating composition of the invention comprises at least one pigment, in particular at least one white pigment, such as titanium dioxide.

For preparing the aqueous coating compositions of the invention the components a) and, if desired, b) and/or, if desired, c) and/or, if desired, d) and/or, if desired, e) and/or, if desired, f) are combined in conventional manner.

Component d) (coalescer) is preferably employed when the minimum film-forming temperature (MFFT) of the coating composition without coalescers is above room temperature.

The invention also provides a process for preparing the aqueous coating composition defined above, comprising the measures of:
i) emulsion-polymerizing acrylates and/or methacrylates with or without ethylenically unsaturated hydrocarbons in aqueous phase and in the presence of a protective colloid and
ii) if desired, adding pigment and/or filler, and/or leveling assistant and/or coalescer, and/or polymeric thickener and/or additives, to the aqueous emulsion polymer.

The invention further provides for the use of (meth)acrylate dispersions prepared in the presence of protective colloids for extending the open time of coating compositions.

The coating compositions of the invention are especially suitable for the coating of surfaces of all kinds. They are employed in particular as paints or as food coatings.

The examples which follow illustrate the invention, without restricting it.

### EXAMPLE 1

A polymerization reactor equipped with metering devices and temperature regulation was charged with 7 p of PVA (polyvinyl alcohol, as a 20% strength aqueous solution), 13 p of water, 0.14 p of dodecanethiol, 0.05 p of tertiary-butyl hydroperoxide and 0.04 p of ascorbic acid. At 70° C. a mixture of 4.7 p of PVA (as a 20% strength aqueous solution), 0.6 p of acrylic acid, 23.3 p of MMA (methyl methacrylate), 23.3 p of BuA (butyl acrylate) and 21 p of water was metered in over 3 hours. Metered in in parallel with this were a solution of 0.2 p of tertiary-butyl hydroperoxide in 1.4 p of water and a solution of 0.15 p of ascorbic acid in 1.7 p of water. 30 minutes after the end of metering a solution of 0.03 p of ascorbic acid in 0.37 p of water was metered in over 30 minutes. After a total postpolymerization time of 1.5 hours, 0.05 p of tertiary-butyl hydroperoxide in 0.35 p of water and 0.07 p of sodium formaldehyde-sulfoxylate in 0.66 p of water were added at 60° C. At <30° C. neutralization was carried out using 1.26 p of sodium hydroxide (as a 10% strength aqueous solution).

A pure acrylate dispersion stabilized only with polyvinyl alcohol showed a solids content of 50.2% and a glass transition temperature T_{g} of 16.6° C.

The particle size distribution showed a mean diameter d_{w} of 278 nm and a d_{w}/dₙ value of 1.89.

The dₙ value here is the numerical mean (number length mean) and the d_{w} value is the ponderal mean (De Broucker mean). These values are described in the literature: for example, in NF X11-632-2 and in NF ISO 9276-2 of Jun. 1,2000.

The values reported for dₙ and d_{w} in this description were determined by means of Ar laser aerosol spectroscopy. This method is described, for example, by J. P. Fischer and E. Nolken in Prod. Colloid & Polymer Sci., 77, 180 (1988).

### EXAMPLE 2

Procedure as for example 1 but with initial charge of 13 p of water, 0.05 p of dodecanethiol, 0.05 p of tertiary-butyl hydroperoxide and 0.04 p of ascorbic acid. At 70° C. a mixture of 11.7 p of PVA (as a 20% strength aqueous solution), 0.6 p of acrylic acid, 24.1 p of styrene, 23.1 p of BuA (butyl acrylate) and 23.6 p. of water was metered in over 3 hours.

This styrene/acrylate dispersion, stabilized only with polyvinyl alcohol, showed a solids content of 50.2% and a glass transition temperature Tg and also a minimum film-forming temperature MFT of 23.2° C. in each case.

The particle size distribution showed a d_{w} value of 336 nm and a d_{w}/dₙ value of 2.335.

### EXAMPLE 3

A polymerization reactor equipped with metering devices and temperature regulation was charged with 24.6 p of water and 0.02 p of APS (ammonium peroxodisulfate). At 80° C. a mixture of 1.3 p of tri-tert-butylphenyl ether sulfate, 1.3 p of methacrylic acid, 22.6 p of MMA (methyl methacrylate), 21.3 p of BuA (butyl acrylate) and 25.5 p of water was metered in over 3.5 hours. 30 minutes after the end of metering neutralization was carried out hot with 0.9 p of ammonia. After a total postpolymerization time of 1 hour neutralization was repeated, this time cold, with 0.9 p of ammonia (as a 12.5% strength aqueous solution), to a pH of 8.5-9. The straight acrylate dispersion, stabilized only with emulsifiers, had a solids fraction of 46% and a glass transition temperature of 27° C. The particle size amounted to d_{w}=361 nm and d_{w}/dₙ=2.900.

### EXAMPLE 4

Procedure as for example 1, but with initial charge of 19.6 p of water, 0.3 p of tri-tert-butylphenyl ether sulfate (as a 12.5% strength aqueous solution) and 0.02 p of APS (ammonium peroxodisulfate). At 80° C. a mixture of 0.9 p of tri-tert-butylphenyl ether sulfate (as a 50% strength aqueous solution), 1.3 p of methacrylic acid, 22 p of MMA (methyl methacrylate), 20.7 p of BuA and 21.3 p of water was metered in over 3.5 hours. 30 minutes after the end of metering neutralization was carried out hot with 0.9 p of ammonia (as a 12.5% strength aqueous solution. After a total postpolymerization time of 1 hour neutralization was repeated, this time cold, with 0.9 p of ammonia (as a 12.5% strength aqueous solution), to a pH of 8.5-9 and, as an afteraddition, 10.7 p of PVA (as a 20% strength aqueous solution) were added. The straight acrylate dispersion had a solids fraction of 48% and a glass transition temperature of 28° C. The particle size amounted to d_{w}=119 nm and d_{w}/dₙ=1.076.

### EXAMPLE 5

Procedure as for example 1, but with initial charge of 19.6 p of water, 0.3 p of tri-tert-butylphenyl ether sulfate and 0.02 p of ammonium peroxodisulfate. At 80° C. a mixture of 0.9 p of tri-tert-butylphenyl ether sulfate (50% strength), 1.3 p of methacrylic acid, 22 p of methyl methacrylate, 20.7 p of butyl acrylate and 21.3 p of water was metered in over 3.5 hours. 30 minutes after the end of metering neutralization was carried out hot with 0.9 p of ammonia (12.5% strength). After a total postpolymerization time of 1 hour neutralization was carried out again, this time cold, with 0.9 p of ammonia (12.5% strength) to a pH of 8.5-9. The straight acrylate dispersion, stabilized only with emulsifiers, had a solids content of 46% and a glass transition temperature of 28° C. The particle size determined by the laser aerosol method amounted to d_{w}=110 nm with a distribution d_{w}/dₙ of 1.093.

### EXAMPLE 6

Procedure as for example 1, but with initial charge of 19.7 p of water, 1.2 p of nonylphenol polyglycol ether containing 30 EO units (20% strength), 0.3 p of ethylene oxide-propylene oxide block polymer sulfate containing 20 EO units (50% strength) and 0.027 p of ammonium peroxodisulfate. At 80° C. a mixture of 24.3 p of styrene, 20.7 p of 2-ethylhexyl acrylate, 1.9 p of methacrylic acid, 1.1 p of methacrylamide in 17.5 p of water and 6 p of nonylphenol polyglycol ether containing 30 EO units (20% strength), 1.4 p of ethylene oxide-propylene oxide block polymer sulfate containing 20 EO units (50% strength) and 0.05 p of APS was metered in over 4 hours. 15 minutes after the end of monomer metering 0.2 p of ammonium peroxodisulfate in 1.1 p of water and 0.067 p of sodium bisulfite in 1.2 p of water were metered in. After a total postpolymerization time of 1 h neutralization was carried out with 1.8 p of ammonia (12.5% strength) and the mixture was cooled. The styrene acrylate dispersion, stabilized only with emulsifiers, had a solids content of 50% and a glass transition temperature of 19° C. The particle size determined by the laser aerosol method amounted to d_{w}=129 nm with a distribution dw/dn of 1,041.

Performance Tests

The dispersions prepared by the process described above were processed in the gloss paint formula described below, and subjected to performance testing.

The gloss paint formula used was a formulation for dispersion coatings with paintlike character (definition as per DIN 55945, 1999-07). The pigment volume concentration (PVC) of the formulation was <20%.

The gloss emulsion paint was prepared in accordance with the following recipe (ppw=parts by weight):
242 ppw water
242 ppw 1,2-propylene glycol
52 ppw Dispex GA 40 (commercial product from Ciba Specialty Chemicals;
dispersant containing ammonium salt of an acrylic acid copolymer)
10 ppw AMP 90 (2-amino-2-methyl-1-propanol)
20 ppw defoamer BYK 022
20 ppw biocide Mergal K7
   were mixed, 2079 ppw titanium dioxide Kronos 2190 were introduced with stirring, and the mixture was then dispersed for 20 minutes using a dissolver, with a toothed disk, with a peripheral speed of at least 14 m/s. After the pigment dispersion had cooled,
185 ppw binder dispersion
80 ppw pigment dispersion were mixed with stirring.

While continuing stirring at moderate speed,
1.8 ppw ammonia (25% strength)
18.6 ppw 1,2-propylene glycol
4.6 ppw Texanol (commercial product from Eastman Chemicals; solvent containing 2,2,2-trimethyl-1,3-pentanediol monoisobutyrate),
and at the end the thickener mixture
10.1 ppw Mowilith LDM 7002 (approximately 18% strength in water) were added.

The coating compositions prepared were stable on storage and gave. surprisingly positive results for open time and for blocking resistance.

Testing of the open time at the edge of a paint film (wet edge open time) was carried out in accordance with the following method.

The test paint was applied to a nonabsorbent substrate using a 100 μm box-type coating bar. Immediately thereafter a stopwatch was started. The substrate was fixed vertically and after three minutes was coated twelve times from left to right, horizontally, using a paint-saturated brush and applying a gentle pressure.

This operation was repeated every three minutes until the paint film dried.

The end of the open time was reached as soon as a “seam” became clearly visible at the brushed-in edge.

The blocking resistance or blocking is a measure of the surface tack of two paint films pressed against one another, such as occurs between window and frame, for example.

The blocking resistance was determined as follows.

The test paint was applied to a contrast chart (Leneta®) using a 50 μm spiral-wound coating bar. The coated contrast chart was subsequently dried under standard conditions (23° C., 50% relative humidity) for 24 hours. The dried contrast charts were cut into strips which were placed crosswise with the coated sides against one another, so as to produce a defined contact area of the paint films. These contact areas were loaded with a 2 kg weight at room temperature for one hour.

The weight force (g/sqinch, corresponding to g/6.76 cm²) subsequently required to separate the paint films was taken as a measure of the blocking. The lower the figure, the better the blocking resistance.

The dispersions of the examples in a selected gloss paint formula, compared with standard dispersions, showed a doubling to trebling of the open time and a halving of the blocking results. The results are set out in the table below.

TABLE

| | Monomers and | Open time | Blocking |
|---|---|---|---|
| Example No. | stabilization | (min) | (g/6.76 cm²) |
| I | Acrylate with PVA^{1), 2)} | 13 | 1100 |
| C-I | Acrylate with emulsifier³⁾ | 4 | 3000 |
| II | Styrene/acrylate with | 10 | 1600 |
| | PVA^{1), 4)} | | |
| C-II | Styrene/acrylate with | 4 | 2500 |
| | emulsifier⁵⁾ | | |

¹⁾PVA = polyvinyl alcohol
²⁾PVA stabilized straight acrylate dispersion from ex. 1
³⁾straight acrylate dispersion stabilized with emulsifiers, as per ex. 3
⁴⁾PVA stabilized styrene acrylate dispersion from ex. 2
⁵⁾styrene acrylate dispersion stabilized with emulsifiers, as per ex. 6

The experiments below show the effect of a wide variety of stabilizer systems on the open time and the blocking behavior.

For example C-III an emulsifier-stabilized, finely divided straight acrylate dispersion as per example 5 was used which had a d_{w} value of 1 10 nm.

For example C-IV an emulsifier-stabilized, coarsely divided straight acrylate dispersion as per example 3 was used which had a d_{w} value of 350 nm.

For example C-V a protective-colloid-stabilized, finely divided straight acrylate dispersion as per example 4 was used which had a d_{w} value of 120 nm and in which the protective colloid had been added after the preparation of the dispersion.

For example III a protective-colloid-stabilized, straight acrylate dispersion as per example 1 was used which had a d_{w} value of 270 nm and in which the protective colloid had been added during the preparation of the dispersion.

The open time and blocking behavior were determined as described above.

The experiments were carried out with the above-described test recipe for gloss paints.

The results are set out in the table below.

TABLE

| | Monomers and | Open time | Blocking |
|---|---|---|---|
| Example No. | stabilization | (min) | (g/6.76 cm²) |
| C-III | Acrylate with emulsifier¹⁾ | 3 | 548 |
| C-IV | Acrylate with emulsifier²⁾ | 4 | 188 |
| C-V | Acrylate with afteradded | 3 | 772 |
| | PVA^{3), 4)} | | |
| III | Acrylate with PVA^{3), 5)} | 7 | 342 |

¹⁾straight acrylate dispersion stabilized with emulsifiers
²⁾straight acrylate dispersion stabilized with emulsifiers and broader distribution than V-III
³⁾PVA = polyvinyl alcohol
⁴⁾PVA stabilized straight acrylate dispersion; dispersion as in example 3
⁵⁾PVA stabilized straight acrylate dispersion

1. An aqueous coating composition comprising
a) a polymer dispersion based on (meth)acrylate homopolymers and/or (meth)acrylate copolymers prepared by emulsion polymerization in the presence of a protective colloid,
b) optionally containing, pigments and/or fillers, with a pigment volume concentration (PVC) of 0 to 30%,
c) optionally containing, leveling assistants,
d) optionally containing, coalescers,
e) optionally containing, polymeric thickeners, and
f) optionally containing, further, additives.

2. The aqueous coating composition as claimed in claim 1, wherein component a) is selected from the group consisting of homopolymer or copolymer derived from esters of acrylic acid with monohydric aliphatic alcohols having one to ten carbon atoms, homopolymer or copolymer derived from esters of methacrylic acid with monohydric aliphatic alcohols having one to ten carbon atoms, and copolymer derived from esters of acrylic acid and/or of methacrylic acid with monohydric aliphatic alcohols having one to ten carbon atoms and ethylenically unsaturated hydrocarbons.

3. The aqueous coating composition as claimed in claim 1, wherein the protective colloid for preparing component a) is polyvinyl alcohol.

4. The aqueous coating composition as claimed in claim 1, wherein component c) is present and is a water-miscible polyhydric alcohol.

5. The aqueous coating composition as claimed in claim 1, wherein component d) is present and is an organic solvent which is immiscible or of low miscibility with water, and by which the minimum film-forming temperature is lowered.

6. The aqueous coating composition as claimed in claim 1, wherein component e) is present and is a hydrophobically modified polyurethane and/or a hydrophobically modified polyacrylate.

7. The aqueous coating composition as claimed in claim 1, further comprising component b), present as at least one pigment and/or at least one filler.

8. The aqueous coating composition as claimed in claim 7, comprising only pigments and/or fillers having mean particle sizes D₅₀ of less than or equal to 0.4 μm.

9. A process for preparing the aqueous coating composition as claimed in claim 1, comprising:
i) emulsion-polymerizing acrylates and/or methacrylates with or without ethylenically unsaturated hydrocarbons in aqueous phase and in the presence of a protective colloid to form an aqueous emulsion polymer and,
ii) optionally, adding pigment filler, leveling assistant, coalescer, polymeric thickener, additives, or a mixture thereof, to the aqueous emulsion polymer.

10-11. (cancelled).

12. The aqueous coating composition as claimed in claim 1, wherein component a) is a copolymer derived from esters of acrylic acid and/or of methacrylic acid with monohydric aliphatic alcohols having one to ten carbon atoms and with ethylene and/or styrene.

13. The aqueous coating composition as claimed in claim 4, wherein component c) is 1,2-propylene glycol.

14. The aqueous coating composition as claimed in claim 5 wherein said organic solvent is a polyhydric alcohol having ester and/or ether functional groups.

15. A process for extending the open time of coating compositions comprising preparing (meth)acrylate dispersions in the presence of protective colloids.

16. A process for aqueously coating food comprising preparing (meth)acrylate dispersions in the presence of protective colloids and coating food with said (meth)acrylate dispersions.

17. An aqueous coating composition as prepared by the process of claim 9.
